(19) United States
(12) Patent Application Publication
(10) Pub. No.: US 2011/0192925 A1
(43) Pub. Date: Aug. 11, 2011

(54) MACHINE FOR OBTAINING RUBBER PELETS FROM USED TIRES

(76) Inventor: Gerardo Pagaza-Melero, Cuajimalpa (MX)

(21) Appl. No.: 13/054,770

(22) PCT Filed: Jul. 15, 2008
(86) PCT No.: PCT/IB2008/001838

§ 371 Date: Apr. 18, 2011

(51) Int. Cl. B29B 17/00; B02C 18/16

(52) U.S. Cl. 241/159

(57) ABSTRACT

A machine for obtaining rubber pellets from used tires is described comprising: a frame; a first pair of cutting rollers, which cuts the tire segment in strips as said tire segment passes through both cutting rollers. The machine further comprises feeders, which receive the strips coming from the first pair of cutting rollers and align them one following the other; and a second pair of cutting rollers, which receive the strips coming from said feeding means and which cut the strips in the form of pellets. The tires fibers and cords remain at the surface level or encapsulated inside the obtained pellets.

### TECHNICAL FIELD

The present invention is related to the recycling techniques of the diverse members constituting a tire, and more particularly, it is related to a machine for obtaining rubber pellets from used tires.

### BACKGROUND OF THE INVENTION

Nowadays, due to the constant growing of the number of vehicles, the tire disposal has increased year to year. It is estimated that in Mexico 30 million of tires are yearly disposed of, and in the United States, about a tire per habitant, representing one of the most severe pollution problems in last times, moreover considering the great complexity to store, destroy or to find a useful purpose for such big volumes of waste tires. One main reason for this problem is the physicochemical properties acquired by the tires when vulcanized, making their removal, recycling or transformation highly complicated.

In Mexico, typically the used tires are found on the streets, abandoned lands, sky open waste disposals, and in few cases, in sanitary waste fills. For this reason said fills turn quickly into a health problem, since pests, such as rats and mosquitoes, are developed therein.

Recently, used tires as boilers fuel has been used by the Cement Industry, since tires are mainly formed by hydrocarbons and have a high heat capacity very similar to the fossil fuels used in this Industry, and even higher than coal. Tires are incinerated at temperatures of about 1450° C., which according to this Industry, assures a complete combustion without residues, such as soot and other pollutants. At the present time however, only a restricted amount of tires for this purpose is allowed.

The use as filling material in highways and bridges has been a further application for used tires, however, due to their physical and chemical features, this use in particular is very limited.

Regarding tires recycling, there are technologies where the main materials from which the tire is manufactured are recovered, i.e., rubber, polymeric and steel fibers and cords. These recovered materials are mainly used to make new tires, to manufacture carpets, waterproofs, cast iron, cork and rubber agglomerates, shoe soles, etc. Moreover, the old tires are re-vulcanized with new rubber. When recycling tires, these are divided, trimmed or pulverized to obtain particles, strips, sheets or pellets capable of being incorporated in the above mentioned products and processes.

Certainly, however, due to the particular structure of a tire, having within polymeric and steel cords between the rubber layers, its recycling results complicated, thus, the obtainment of particles, mainly pellets, having a homogeneous structure, is not a simple or direct task.

In order to deeply explain the above, it is worth mentioning that a tire has a structure having two main defined parts; a tread being the tire-to-ground contact point, and the sidewalls which allows the tire to be mounted on a rim.

In relation to the above, the tread is conformed by an inner layer and an outer layer, which is properly the tire-to-ground contact point. The inner layer is mainly comprised by a carcass or frame, having within a sealant rubber layer, polymeric fiber cords layers coated with rubber, and depending on the tire type, stabilizing belts. On the other hand, the outer layer is essentially comprised of rubber, with ribs, grooves, stripes and shoulders being provided therein, forming the tire pattern.

To better describe the inner layer, it is to be mentioned that the carcass or frame is comprised at its most inner part by the sealant rubber layer, which as being impermeable to air, functions to retain it. Over the sealant rubber layer, polymeric material cord layers, such as rayon, polyester, nylon or steel being coated with rubber to avoid any friction therebetween, are disposed. Finally, at the most outer part of the carcass, and over the polymeric or metallic cords, there are optionally the stabilizing belts, having as main function to provide stability and uniformity to the tread when the tire is spinning at high speeds, thus contributing to the strength, lower wearing, traction and tire driving. Steel is the most common material used in the stabilizing belts, since provides force and stability to the tread without adding too much weight to the tire.

Now, regarding the second of the main parts forming the tread, i.e., the outer layer, it is to be mentioned that the grooves provided in said outer layer are designed to leak water and residues, to cool the tire, and to generate traction avoiding lateral slipping of the vehicle. In addition, the grooves are designed to eliminate the noise caused by the air passing through the channels. On the other hand, the stripes included on the tread have the function of increasing the tire refrigeration or cooling, and to contribute to its traction ability. While the shoulders join the tread with the sidewalls, the shoulders are designed taking into consideration the sidewalls flexion, resulting in a perfect setting of the tread on the ground. Moreover, the shoulders help to the weight transfer over the tire, when a vehicle gets into a curve.

On the other hand, as mentioned above, the sidewalls are the second basic structure of a tire, each one including a flange forming the inner ring thereof. The sidewalls of the tire are joined to the tread through the shoulders, and they are conformed by high fatigue strength rubber compounds. In addition, cords of steel may be present within, providing a higher strength.

Moreover, the flange is formed by ring-shaped steel wires. To prevent corrosion, the wires are coated with copper and are insulated with rubber compounds to avoid any friction. The flange acts to anchor the tire to the rim and it should have high breaking strength, so that the flange is filled with a hard rubber compound to support the tire mounting difficulties. During the tire manufacturing, the flanges are joined to the sidewalls when the assembling process occurs being completely joined thereafter by the vulcanization process.

Once explained the basic structure of a tire, it is to be mentioned that there are in the prior art, machines which allow separating the two main parts comprising a tire, such as the Mexican Patent No. 188,444 granted to the same inventor as of the machine being described in the present specification. Said patent is related to a tire cutting machine, whereby it is possible to separate efficiently the sidewalls from the tread allowing to decrease the volume occupied by the used tires. However, said patent does not mention how to process the separated parts to obtain homogeneous particles or pellets capable of being recycled in the above mentioned process and products.

U.S. Pat. No. 3,817,463 discloses a tire shredding machine, wherein the tire is fed completely to said machine and which is shredded by two pairs of rollers, one pair disposed bellow the other. Particularly, after passing the first pair of rollers, the shredded fragments are immediately fed to the second pair. The tire shred is very random resulting in highly heterogeneous fragments. Further, this machine does not consider the need of previously separating the flange from the tire, being one of the hardest elements of a tire. A randomized shred will need a high energy consumption to shred the tire flange and other hard parts thereof.

U.S. Pat. No. 3,931,935 discloses another shredding machine, wherein the tire is fed completely making a non-logic cut thereof, i.e., diverse cutting means make indistinct cuts.

Likewise, in the prior art, U.S. Pat. No. 4,613,087 discloses a machine having the purpose of cutting used tires; said machine employs a structure having a cylindrical anvil roller rotationally mounted therein. Further, the machine employs a pair of blade rollers in the structure, rotating in a parallel axis with respect to the pivoting axis of the anvil roller, said blade rollers are angularly spaced apart from each other with respect to the anvil roller axis, such that the tires pass by the anvil roller between the blade rollers, thus obtaining rhombus-shaped, almost rectangular-shaped, tire cuts. However, this machine as others existing does not consider the tire structure, since the tires are fed to the machine as a whole, i.e, without separating the sidewalls from the tread, resulting in a high energy consumption, besides the fact that the rhombus-shaped rubber cuts obtained are not uniform due to the randomized cut, then the cords and fibers protrude from the rhombus cuts, which may harm the personnel working with them, and not being appropriate for recycling purposes, particularly when they have to be mixed with other substances.

U.S. Pat. No. 5,115,983 is another important prior art document to be mentioned because it discloses a machine comprising a pair of platforms to hold the tire, wherein the tire rubber is cut by high pressure fluids. However, the high operating costs involved with high pressure fluids is the most important inconvenience of this kind of machines besides it is required a cleaning and recirculation process for the fluid used in the machine operation.

In the U.S. Pat. No. 6,036,128 a tire shredding machine is disclosed, which includes a safety hood and cutting elements, the main feature of said machine being the feeding of half-tires, specifically, the tire is diametrically divided in two parts, such that each half includes a tread portion and sidewalls. However, since these parts are not removed from the tire, non-homogeneous particles are obtained.

In the International Patent Application No. PCT/IB2006/000861, filed by the same inventor as the machine that will be described below, a process of cutting efficiently and logically the tire elements is described, considering the sidewalls and tread structure, however, a machine of great capacity is still necessary, which allows an intensive and organized tire cutting.

As seen, the prior techniques are limited to a random shred of the used tires, or alternatively, by means of expensive machines, which do not provide a logical cut to obtain the maximum benefit of the parts constituting the tire, such that they can be recycled. Further, such techniques do not distinguish the particular structural relationship between the rubber, the polymeric cords and the metallic cords in the tire. In other words, the prior art machines carry out a raw and random cut, while what is required is a precise and organized cut to form rubber pellets capable of being recycled or mixed with other particles.

### BRIEF DESCRIPTION OF THE INVENTION

In the light of the above, the overcoming of the drawbacks of the existing shredding or recycling machines for used tires has been pursued, and to provide a machine for obtaining rubber pellets from used tires, wherein said machine makes precise and logic cuts over the main parts of a tire, i.e., the tread and sidewalls, obtaining homogeneous rubber pellets capable of an easy management in recycling processes.

Particularly, the machine for obtaining rubber pellets from used tires of the present invention comprises a frame; a first pair of cutting rollers including a pivoting axis to be rotationally mounted on the frame, such that a roller is spaced apart from the other and rotates in an opposite direction, wherein at least one roller includes cutting discs, each disc being spaced apart from the other disc at a predetermined distance to cut a tire segment feed in the gap formed between both rollers in strips form.

A plurality of elongated guides are provided in the machine, each one having a fixed end attached to the frame and a free end moving between two cutting discs, causing that the strips being cut to be moved away from the first pair of cutting rollers.

The cut strips coming from the first pair of cutting rollers are received by feeding means, which align them one following the other; these strips are processed by a second pair of cutting rollers that include a pivoting axis to be rotationally mounted on the frame, such that a roller is spaced apart from the other and rotates in the opposite direction, the second pair of rollers receive the strips coming from said feeding means, wherein at least one roller of the second pair includes cutting discs, each disc being spaced apart from the other disc at a predetermined distance in order to cut the strips width-wise, thus obtaining rubber pellets.

The tire segment comes either from the tire tread or from the sidewalls. Preferably, when the segment comes from the sidewalls, the flange may be first removed before the segment is to be fed to the machine, since this is one of the hardest parts of the tire.

Referring to the above, it is to be noted that an important advantage of the machine of the present invention is the precise cuts made thereby, since the first pair of cutting rollers cut in an homogeneous manner the tire segment as strips, which in turn are also homogeneously cut as rubber pellets by means of the second pair of cutting rollers. Contrary to the prior art, the machine of the present invention carries out precise cuts on the tire, and non indistinct and random cuts which consume a great amount of energy.

In a preferred embodiment of the machine of the present invention, the cutting rollers of the first pair are spaced apart one above the other, defining an upper roller and a lower roller, the upper roller includes cutting discs while the lower roller has a rough surface with microgrooves. Cutting discs of a single edge are preferred for this embodiment.

In a further embodiment, both cutting rollers from the first or second pair of cutting rollers include cutting discs, being double edge cutting discs.

In another embodiment of the present invention, the machine additionally comprises means to sharpen the cutting discs of said first or second pair of cutting rollers, wherein the first sharpening means are mounted on the frame and are contacted by the cutting discs when the edge thereof needs to be recovered.

In a further aspect of the machine of the present invention, the machine for obtaining rubber pellets from used tires additionally comprises means to support the roller axis which includes the cutting discs in said first or second pair of cutting rollers. This feature has the object of maintaining a continuous separation between said rollers of the first or second pair, avoiding their distortion, obtaining homogeneous rubber pellets.

As may be seen from the above, an object of the present invention is to provide a machine for obtaining rubber pellets from used tires, wherein the main parts of the tire are uniformly and systematically cut.

Another object of the invention is to provide a machine for obtaining rubber pellets from used tires, wherein the pellets are homogeneous, and without any tire cord or fiber protrude therefrom, such that said fibers and cords remain encapsulated within the pellet.

### BRIEF DESCRIPTION OF THE DRAWINGS

The novel aspects considered characteristics of the present invention are set forth particularly in the appended claims, however, the operation together with other objects and advantages of the machine of the present invention will be better understood when reading the following detailed description of certain preferred embodiments in conjunction with the appended drawings, in which:

FIG. 1 is a perspective view of a transversally cut tire portion.

FIG. 2 is a schematic representation of a machine for obtaining rubber pellets from used tires, the machine being built according to a first preferred embodiment of the invention.

FIG. 3 is a side view of the machine for obtaining rubber pellets from used tires built according to the schematic representation of FIG. 2.

FIG. 4 is a top view around the machine section of FIG. 3, wherein the tire segments are fed and cut in strips.

FIG. 5 is a top perspective view of the machine section of FIG. 3, wherein the strips are cut in pellets.

FIG. 6 is a front view of one of the single edge cutting discs used in the machine of FIG. 3.

FIG. 6A is a front view of one of the double edge cutting discs used either in the first pair or in the second pair of cutting rollers.

FIG. 7 is a perspective view of the double edge cutting disc shown in FIG. 6A.

FIG. 8 is a cross-section view of an alternative arrangement of the first pair of cutting rollers of the machine of the present invention.

FIG. 9 is an enlarged view around zone “B” of FIG. 8.

FIG. 9A is an enlarged view of the second pair of cutting rollers used in the second embodiment of the machine of the present invention.

FIG. 10 is a cross-section view of the first pair of cutting rollers in a further embodiment of the machine of the present invention.

FIG. 11 is an enlarged view around zone “A” marked in the first embodiment of the machine illustrated in FIG. 3.

FIG. 12 is a perspective view of the rubber pellets obtained in the machine of the present invention.

FIG. 13 is a schematic representation of a machine for obtaining rubber pellets from used tires, the machine being built according to a second preferred embodiment of the present invention.

FIG. 14 is a top view around the machine section in FIG. 13, wherein the tire segments are fed and cut in strips.

### DETAILED DESCRIPTION OF THE PREFERRED EMBODIMENTS OF THE INVENTION

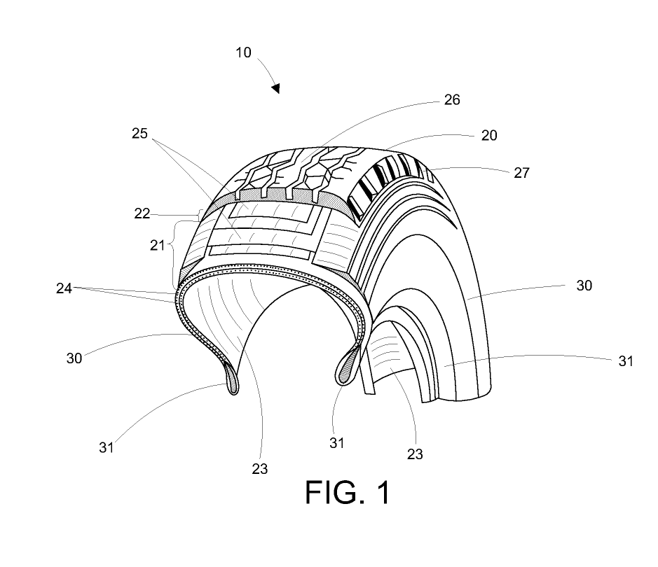

Being convenient to describe the general structure of a tire in order to explain the advantages and the reasons of the elements arrangement of the machine of the present invention, reference is made to FIG. 1 wherein a tire 10 is shown, which is conformed by a tread 20, being the tire-to-ground contact point, and sidewalls 30 to mount the tire 10 to a rim. The tread 20 in turn comprises an inner layer 21 and an outer layer 22, as also seen in this figure. Within the first layer also known as frame or carcass, there is a sealant rubber layer 23, and over this rubber there are diverse layers 24 of polymeric fibers or metallic cords coated with rubber. Stabilizing belts 25 are additionally seen in the tire 10 shown in FIG. 1.

On the other hand, the outer layer 22 has a tread block 26 and shoulders 27 to connect the tread 20 to the sidewalls 30. Particularly, it can be noted that the inner edge of the sidewalls 30 is formed by a flange 31 which allows the tire 10 to resist the mounting and demounting operations of the tire 10 to a rim. The flange is one of the hardest parts of a tire, thus first it is convenient to separate it before any segment from the sidewalls be introduced to the machine described below.

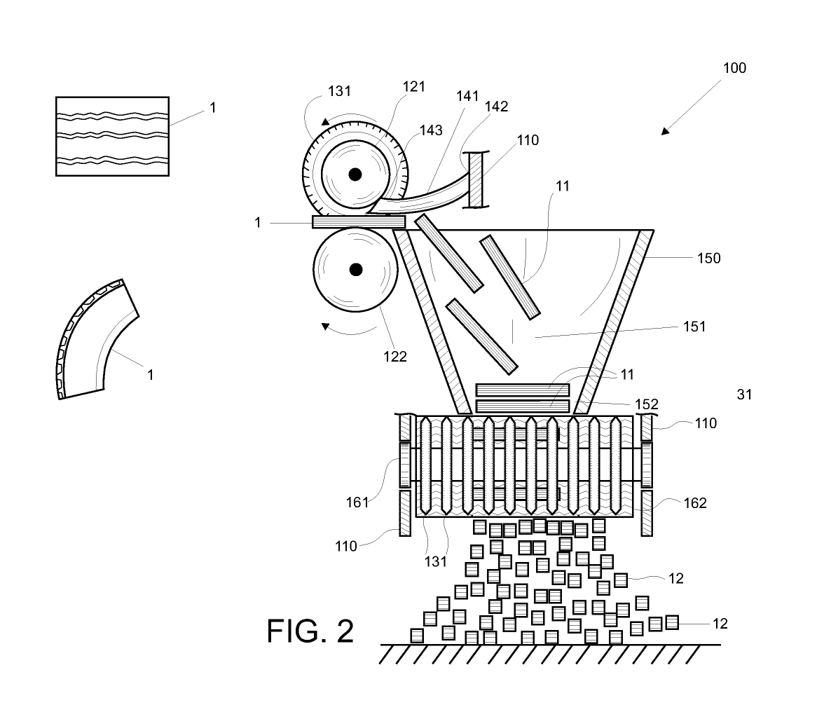

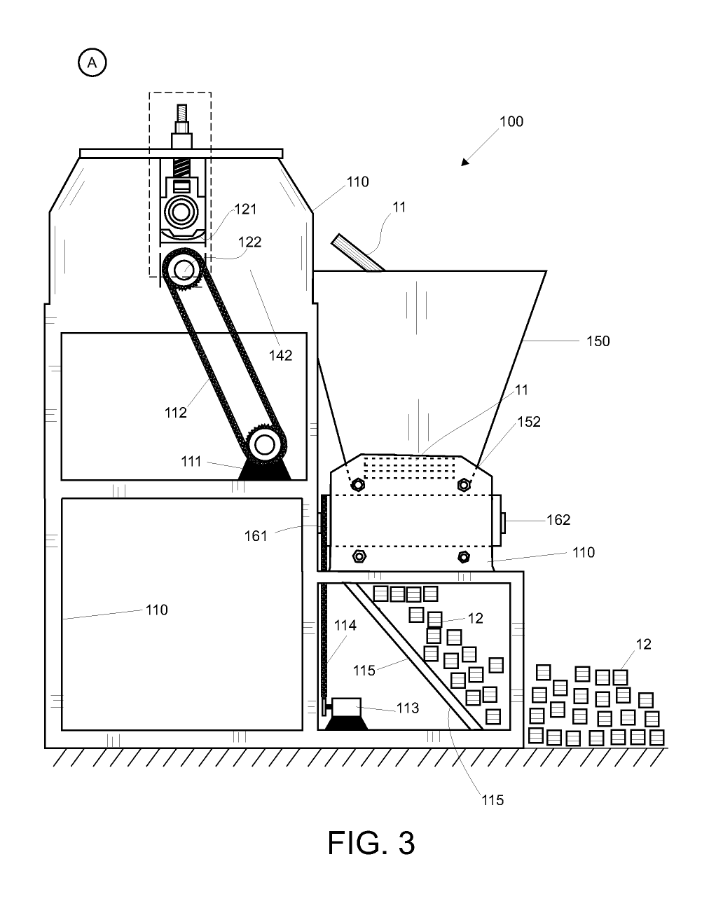

Once the general disposition of a tire has been described, reference is made particularly to FIGS. 2 and 3 a schematic representation of a machine 100 is shown in FIG. 2, for obtaining rubber pellets 12 from used tires and wherein most of the frame 110 has been removed from said machine for clarity purposes. Meanwhile, a side view of the machine 100 is shown in FIG. 3, being built according to FIG. 2 but representing the entire frame 110. Both figures taken together allow a better appreciation of the arrangement and structure of the machine 100, which is the preferred embodiment of the invention, and which should be considered only as illustrative but not limitative thereof.

The machine 100 is fed with tire segments 1, coming from the tread or the sidewalls, the tire segment may be as long as the total length of the tread or as wide as an entire tire sidewall, however, preferably segments from about 20 cm to about 50 cm in length are used. Previously, the separation of the tread from the sidewalls can be made by the machine described in Mexican Patent No. 188,444.

At the frame 110, a first pair of cutting rollers 121 and 121 are rotationally mounted, such that one roller is set and spaced apart above the other, i.e., an upper cutting roller 121 and a lower cutting roller 122 are defined. Both cutting rollers 121 and 122 rotate in opposite directions, wherein the tire segment 1 is fed to the gap formed between both cutting rollers 121 and 122, and it is pulled thereby as said cutting rollers rotate in opposite directions. From this first pair of rollers, the upper cutting roller 121 includes cutting discs 131, which are apart from each other at a predetermined distance in order for the tire segment be cut in strips 11, as said first pair of cutting rollers 121 and 122 rotate.

An enlarged guide 141 may be seen in FIG. 2, however, is to be understood that there is a plurality of said enlarged guides 141, each one having a fixed end 142 attached to the frame 110 and a free end 143 being aside the upper roller surface 121 having the cutting discs 131. These guides 141 act to move away the cut strips 11 from the cutting zone between rollers 121 and 122, since the own curvature of the tire segments would make them to divert and be trapped between the rollers.

Once the tire segment has been cut in strips 11, these require an additional width-wise cutting for obtaining rubber pellets 12. To this end, the strips 11 are received by feeding means, which in the embodiment being described, is a hopper 150 with a descending surface 151 and an elongated outlet 152, which makes the strips 11 to be aligned one following the other at the outlet 153 to be received by the next elements of the machine 100, being the second pair of cutting rollers 161 and 162. Alternatively the feeding means of the present invention may be also a pivotable and slanting platform, wherein a batch of strips 11 be received, then the platform pivots and slants in order to feed a strip on the top of the other to the second pair of cutting rollers 161 and 162.

In order to cut the strips 11 in pellets 12, the second pair of cutting rollers 161 and 162 are rotationally mounted to the frame 110 such that they are side-by-side. These cutting rollers 161 and 162 receive one-by-one the strips 11 from the hopper 150. Additionally, both rollers 161 and 162 of the second pair of cutting rollers rotate in opposite directions and one of them, particularly the cutting roller 161, also has cutting discs 131 that cut the strips 11 at all-wide, thereby obtaining the rubber pellets 12.

As seen from FIGS. 2 and 3, the first pair of cutting rollers 121 and 122 is perpendicular with relation to the second pair of cutting rollers 161 and 162, since the tire segment 1 has to be firstly cut lengthwise to form the strips 11, and then said strips have to be cut width-wise to form the pellets 12. Nevertheless, there is no limitation for the first pair of cutting rollers 131 and 132 to be parallel with relation to the second pair of cutting rollers 161 and 162, provided that the feeding means, such as the hopper 150, be designed to receive the strips 11 and to rotate them about 90°, and then to be fed one over the other to the second pair of cutting rollers 161 and 162, which cut said strips 11 in the form of pellets 12.

Referring again specially to FIG. 3, at the upper half thereof a first motor 111 with a first pulling chain 112 is shown, which moves the first pair of cutting rollers 121 and 122 in the required direction. Similarly, a second motor 113 with a second pulling chain 114 is shown, which connects to the second pair of cutting rollers 161 and 162 to move them in the required direction. Finally, a collecting plate 115 is shown, which receives the rubber pellets 12 just cut and take them out of the frame 110. At the end of plate 115 a reservoir can be disposed to recollect the cut pellets, or a conveying belt may be installed to take the pellets to other location as required.

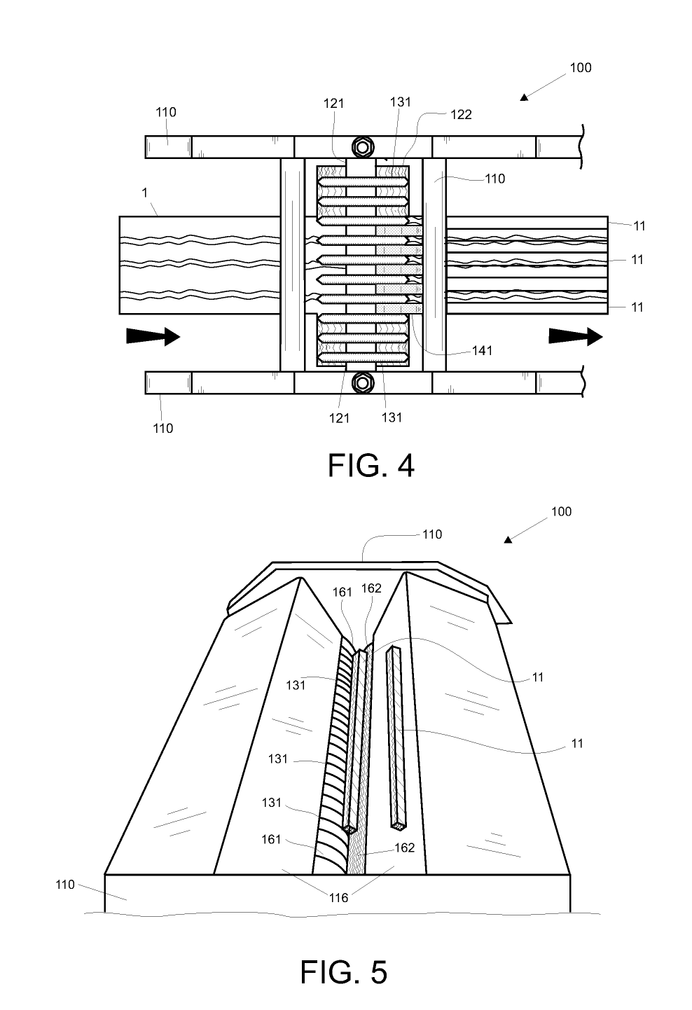

Now reference is made to FIG. 4 which is a top view of the section of the machine 100 of FIG. 3 to describe the preferred characteristics of the main elements of the machine 100 being described, wherein the tire segment 1 is received to be cut in strips 11. In FIG. 4 is shown the lower cutting roller 122 having a rough surface with microgrooves, this having the object of firmly supporting the tire segment 1 to prevent its movement over the lower roller 122 as the segment 1 is cut by the cutting discs 131 of the upper roller 121. The cutting discs 131 are mounted on the upper cutting roller 121 axis of said first pair of cutting rollers. The cutting discs 131 are laterally spaced apart one from the other at a predetermined distance in order to cut the tire segment 1 in strips 11, with an approximate wide from about 3.18 mm to about 76.20 mm (from about ⅛ to about 3 inches). Finally, the guides 141 mounted to the frame 141 are also shown in this FIG. 4, which makes the strips 11 having been cut to move away the zone where the first pair of cutting rollers is mounted.

Now reference is made to FIG. 5, wherein a top perspective view of the section of the machine of FIG. 3 is shown, wherein the strips 11 are cut width-wise to form the pellets. In FIG. 5, the second pair of cutting rollers 161 and 162 may be seen, mounted on the frame 110. Specifically the cutting roller 161 on the left is provided with cutting discs 131.

On the other hand, the other roller, i.e., roller 162 of the second pair of cutting rollers also has a rough surface with microgrooves so the strips 11 can be supported, and to prevent their movement when being cut width-wide by the cutting discs 131. Each one of the cutting discs 131 is mounted on the roller 161 axis, the cutting discs 131 are laterally spaced apart from each other at a predetermined distance to cut the strips to obtain pellets with an average size of from about 3.18 mm to about 76.20 mm (from about ⅛ to about 3 inches).

In this section of the machine 100, the strips 11 are fed and guided between the second pair of cutting rollers 161 and 162 by means of a feeding nozzle 116 conformed by two slanted plates being arranged one in front of the other.

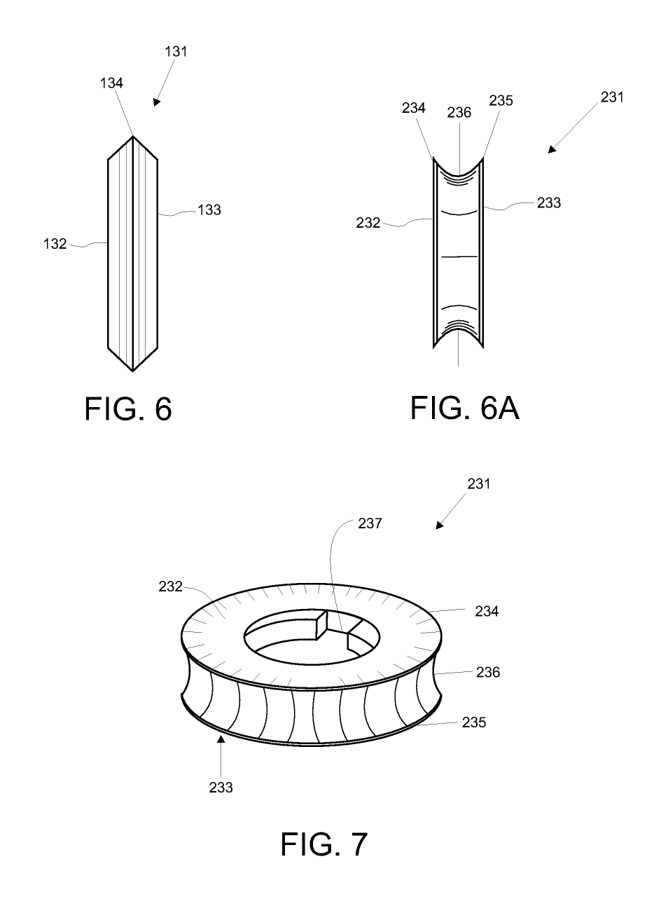

Now reference is made to FIG. 6, wherein a cutting disc 131 is shown, which is used in the machine of FIGS. 3 and 4, these discs are single edge discs and comprise a first face 132, a second face 133 spaced apart from the first face 132 and an edge 134 connecting both faces 132 and 133.

In turn, FIGS. 6A and 7 show an alternative to the cutting discs being used in a second preferred embodiment of the machine wherein both cutting rollers of the first or second pair have cutting discs, preferably being of the double edge type and identified with the reference number 231, and comprising a first face 232 including a first edge 234 in all its perimeter, a second face 233 spaced apart from the first face and including a second edge 235 in all its perimeter, and a separation wall 236 connecting both faces, the separation wall 236 between both faces 232 and 233 has enough wide to let a strip 11, or pellet in the case of the rollers of the second pair, to pass through said wall 236. Particularly, in FIG. 7 is seen that the cutting disc 231 includes a notch 237 provided at the disc inner perimeter 231 in order for this disc to be mounted and fixed over the roller axis which has to include it, in the first or second pair of cutting rollers.

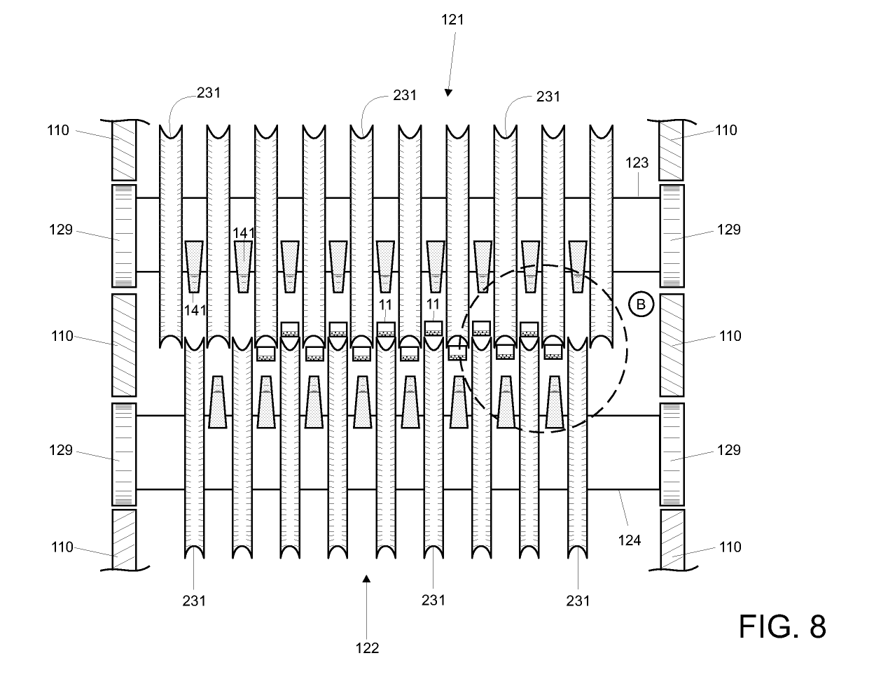

Now reference is made to FIG. 8, showing a first alternative arrangement of the first pair of cutting rollers 121 and 122 in a second embodiment of the machine, wherein the first pair of cutting rollers 121 and 122 includes cutting discs 231. As shown in FIG. 8, the upper cutting disc 121 includes double edge cutting discs 231 mounted on the axis 123 of said upper roller 121, in turn, the lower cutting roller 122 also includes double edge cutting discs 231 mounted on its axis 124. Discs 231 of both rollers 121 and 122 cut the tire segment in strips 11 in the same manner as scissors would but with the difference that the cutting discs have two edged faces. The cutting rollers 121 and 122 are mounted by their axis to the frame 110 by end bearings 129. This same figure allows to appreciate seeing the elongated guides 141, which permits the strips 11 being cut to be moved away from the cutting zones.

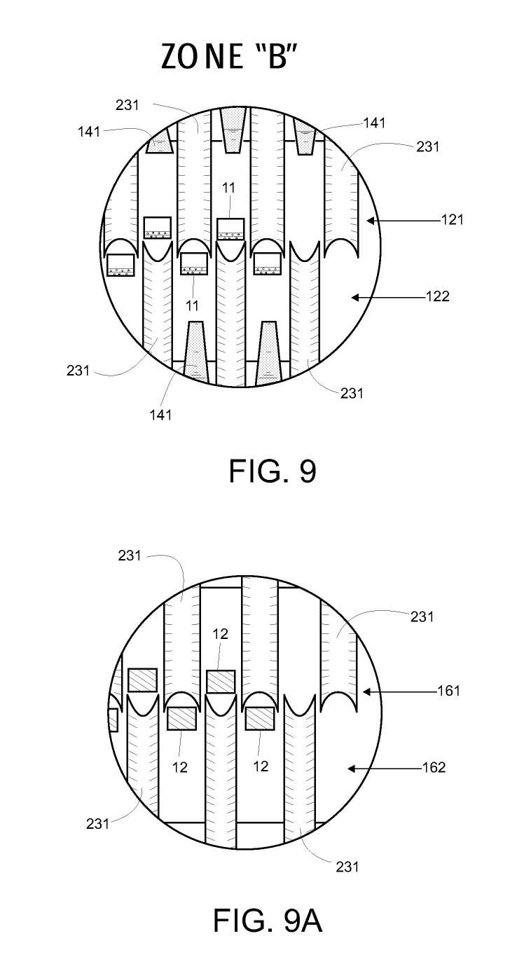

Reference is made to FIG. 9 to better describe how the cutting discs 231 of this second embodiment work; said figure is an enlarged view around zone “B” of FIG. 8, in FIG. 9 is seen that such cutting discs 231 are double edge discs provided on both rollers, the cutting discs are disposed in an intercalated relationship, wherein the cutting discs 231 of the upper roller 121 goes between the cutting discs 231 of the lower roller 122, thereby carrying out said cutting, such like scissors would to form the strips 11, which are moved away from the cutting zone by the elongated guides 141.

In a further embodiment, the arrangement of the cutting discs illustrated in FIG. 9 may also be provided in the second pair of cutting rollers such as illustrated in FIG. 9A, i.e., both rollers of the second pair of cutting rollers 161 and 162 include double edge cutting discs 231 in order for the strips to be cut in pellets 12. The double edge cutting discs 231 of the cutting rollers of the second pair are disposed in an intercalated relationship to cut the strips in rubber pellets 12.

In an embodiment of the machine of the present invention, the same can comprise means to support the axis of each one of the rollers of said first pair or second pair of cutting rollers, preventing the deformation thereof, thus maintaining a homogeneous cut over the tire segment being cut in strips.

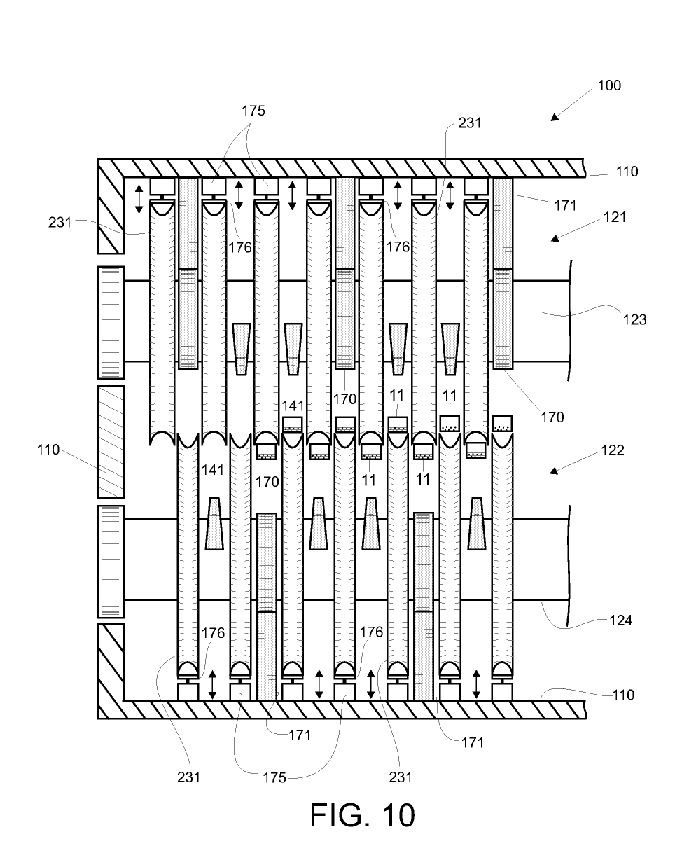

Reference is now made to FIG. 10 to better explain the above, which shows a top view of the additional embodiment, said first support means are bearings 170 surrounding the respective axis 123 and 124 of the first pair of cutting rollers 121 and 122, the bearings 170 are fixedly mounted to the frame 110 by means of an elongated base 171 and they are intercalated between the cutting discs 231 of the respective axis 123 and 124 of each roller of said first pair of cutting rollers 121 and 122. Moreover, instead of the bearings 170, bushings mounted to the frame may be used, by means of the elongated base 171. FIG. 10 allows to observe the elongated guides 141 which function has already been explained above. As mentioned, this feature may be present as well in the second pair of cutting rollers.

In the additional embodiment, the machine may comprise first means to sharpen the cutting discs 231 of the first or second pair of cutting rollers. This feature can also be explained from FIG. 10, these means are provided in the form of motors 175 having a retractile sharpening head 176, and the sharpening head is contacted with said discs 231 every time the edge of the discs 231 needs to be recovered.

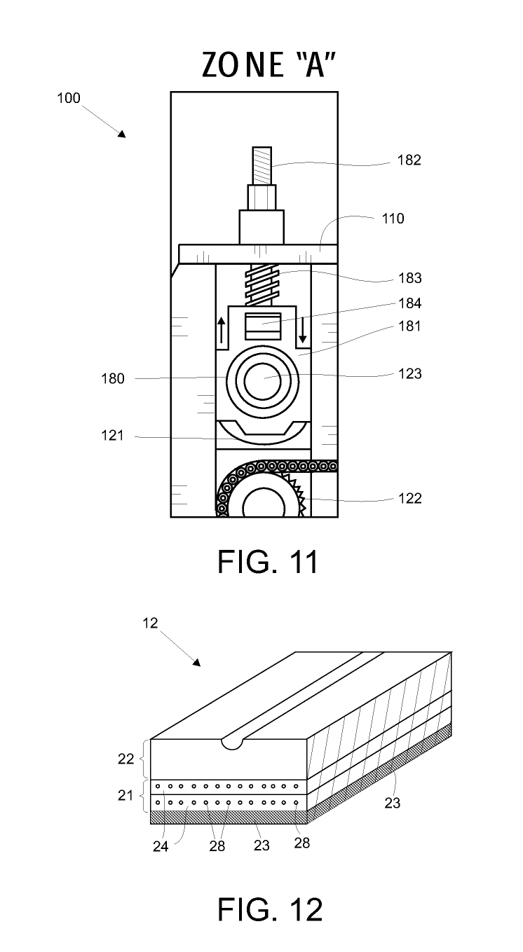

Now reference is made to FIG. 11, which shows en enlarged view of zone “A” shown in FIG. 3. Particularly, the upper roller 121 and the lower roller 122 may be seen in FIG. 11. The machine 100 includes means to adjust the separating distance of the upper cutting roller 121 with respect to the lower cutting roller 122. In other words, the upper cutting roller 121 can slightly travel in the vertical direction, but at the same time, it can keep pressed the tire segment against the lower cutting roller 122. This has the object of being capable of managing tire segments with different thickness, which can be processed by the machine without any adjustments. The arrangement of the first adjusting means is described below.

The adjusting means comprises: an end bearing 180, wherein an axis end 123 of the upper cutting roller 121 is received; a bearing base 181, slidably mounted on the frame 110 to freely move in the vertical direction, and wherein the end bearing 180 is housed; a threaded rod 182 disposed vertically with respect to the frame 110, the lower end of said rod freely goes into the bearing base 181, but is anchored to said base by means of a retainer 184. The upper end of said rod 182 is fixed to the frame 110, such that the bearing base 181 remains separated underneath the frame 110.

Another part of the adjusting means are the elastic means such as the helical spring 183 covering the threaded rod portion 182 remaining between the bearing base 181 and the frame 110. The base 181 allows a slight ascendant movement of the end bearing 180, and consequently, of the axis 123 of the upper cutting roller 121, with the purpose of feeding tire segments of variable thickness, but additionally, the helical spring 183 exerts a descendant pressure over the bearing base 181 and as a consequence, said pressure is transmitted to the upper cutting roller 121 making the tire segment to be pressed against the lower roller 122.

FIG. 12 shows one of the rubber pellet 12 obtained by the machine of the present invention, it is particularly observed a rubber pellet 12 from the tread (see FIG. 1) and therein may be noted the inner layer 21 and an outer layer 22 of the tread. As mentioned above, there is a sealant rubber layer 23 and over this rubber there are several layers 24 of polymeric fibers or metallic cords 28, which are at the surface level or encapsulated inside the pellets, i.e., they do not protrude from any of the faces of the pellet 12. The fact that the cords remain in this manner inside the obtained pellet 12 is a result and an advantage of the systematic and organized cut carried out by the machine of the present invention, therefore the pellet 12 may be safely managed by the workers and may be incorporated in several mixtures, such as concrete for example. When the sidewalls are processed in the machine, the obtained pellets essentially consist of rubber.

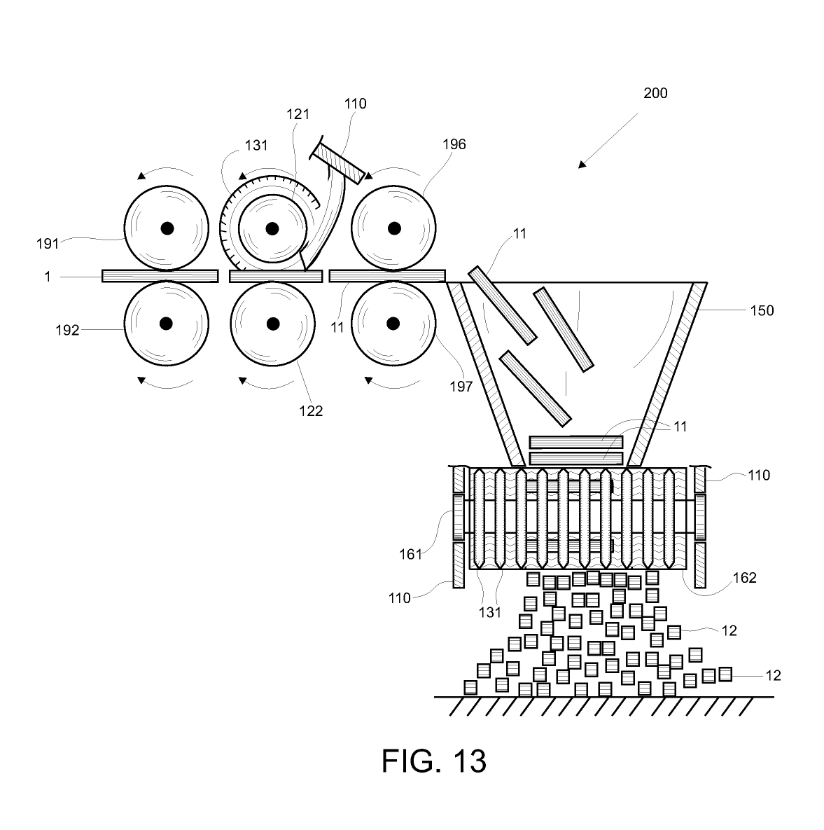

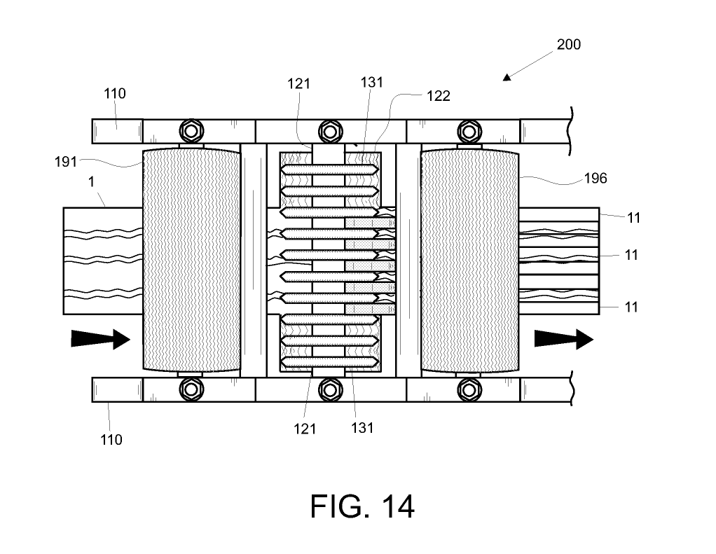

Now then, FIGS. 13 and 14 show a second preferred embodiment of the machine of the present invention identified with the number 200. In this second embodiment, the common elements with respect to the machine of the first embodiment have the same numeric references. Now then, this second embodiment is characterized because a pair of feeding rollers 191 and 192 are mounted to the frame 110 such that one roller is set and spaced apart above the other, i.e., an upper feeding roller 191 and a lower feeding roller 192 are defined. Both feeding rollers 191 and 192 rotate in opposite directions, wherein the tire segment 1 is fed to the gap between both feeding rollers 191 and 192 and is pulled thereby as said feeding rollers rotate in opposite senses. The feeding rollers 191 and 192 makes said tire segment 1 to be received more safely by said first pair of cutting rollers 121 and 122.

Likewise, in this second embodiment of the machine, the strips 11 having been cut by the cutting discs 131 are received by a pair of extraction rollers 196 and 197 rotationally mounted to the frame 110 such that one roller is set and spaced apart above the other, in other words, there is an upper extraction roller 196 and a lower extraction roller 197. Both extraction rollers 196 and 197 rotate in opposite directions, wherein the strips 11, which have been cut by the first pair of cutting rollers 121 and 122, are pulled and trapped by the extraction rollers 196 and 197 as they rotate. The extraction rollers 196 and 197 eject the strips 11, which still need to be cut width-wise to obtain the pellets 12. For this purpose, strips 11 coming from the extraction rollers, are received in the hopper 150 (FIG. 13), which feeds them towards the second pair of cutting rollers 161 and 162.

Emphasizing on FIG. 14, which is a top view of the machine section according to the scheme shown in FIG. 13, the upper feeding roller 191 having a rough surface with microgrooves may be seen, these microgrooves are also provided over the lower feeding roller surface which cannot be seen in FIG. 14. The microgrooves make the tire segment to be taken and firmly pulled between the feeding rollers.

As in the case of the feeding rollers from FIG. 14 it also can be mentioned that both extraction rollers from which only the upper extraction roller 196 can be seen, are provided with microgrooves at their surfaces allowing to firmly pull the strips 11 previously having been cut.

Summarizing, the machine of the present invention makes a selected and logic cut allowing an appropriate cut of a tire, while consuming less energy by cutting manner with respect to any other prior art machine. The machine has a processing capacity of about 200 to 500 tires per hour, i.e., from 6,000 to 12,000 tires per day.

Although in the above description are shown and described some preferred embodiments of the present invention, many possible modifications thereto are possible, for example the cutting discs type or the feeding means conveying the strips towards the second pair of cutting rollers wherein they are cut in pellet form. Therefore, the present invention shall not be considered limited to the above description but for that established in the prior art and for what is set forth in the appended claims.

1. A machine for obtaining rubber pellets from used tires, comprising:
a) a frame;
b) a first pair of cutting rollers including a pivoting axis to be rotationally mounted on the frame such that one roller is spaced apart from the other and rotating in opposite directions, wherein at least one roller includes cutting discs, each cutting disc being spaced apart from the other at a predetermined distance to cut a tire segment being fed between both rollers in the form of strips;
c) a plurality of elongated guides, each one having a fixed end attached to the frame and a free end which goes between both cutting discs causing the strips being cut to be moved away from the first pair of cutting rollers;
d) feeding means receiving the strips coming from the first pair of cutting rollers and which align them one following the other; and
e) a second pair of cutting rollers including a pivoting axis to be rotationally mounted on the frame such that one roller is spaced apart from the other and rotating in opposite directions, the second pair of rollers receive the strips coming from said feeding means, wherein at least one of the rollers of the second pair includes cutting discs, each disc being spaced apart from the other at a predetermined distance to cut the strips width-wise, obtaining rubber pellets.

2. A machine for obtaining rubber pellets from used tires according to claim 1, wherein the cutting rollers of the first pair are spaced apart one above the other, defining an upper roller and a lower roller, from which the upper roller includes cutting discs while the lower roller has a rough surface with microgrooves at its surface.

3. A machine for obtaining rubber pellets from used tires according to claim 2, wherein each cutting disc comprises: a first face, a second face spaced apart from the first face, and an edge connecting both faces.

4. A machine for obtaining rubber pellets from used tires according to claim 1, wherein both cutting rollers from the first or second pair of cutting rollers include cutting discs.

5. A machine for obtaining rubber pellets from used tires according to claim 4, wherein the cutting discs are double edge cutting discs, each one comprising a first face including a first edge at its whole perimeter, and a second face spaced apart from the first face and including a second edge at its whole perimeter, and a separation wall connecting both faces.

6. A machine for obtaining rubber pellets from used tires according to claim 5, wherein the separation wall of the double edge discs of the first pair of cutting rollers has enough length to allow the passage of a trip through said wall cut from the tire segment.

7. A machine for obtaining rubber pellets from used tires according to claim 5, wherein the separation wall of the double edge discs of the second pair of cutting rollers has enough length to allow the passage of a rubber pellet through said wall.

8. A machine for obtaining rubber pellets from used tires according to claim 1, wherein the strips cut by the first pair of cutting rollers have a width of from 3.18 mm to 76.20 mm.

9. A machine for obtaining rubber pellets from used tires according to claim 1, wherein the cut rubber pellets have an average size of from 3.18 mm to 76.20 mm.

10. A machine for obtaining rubber pellets from used tires according to claim 1, wherein said feeding means are a hopper with a descending surface and an elongated outlet to align the strips one following the other at said hopper outlet.

11. A machine for obtaining rubber pellets from used tires according to claim 1, wherein said feeding means are a pivotable and slanting platform; wherein the strips are received by the platform, which thereafter pivots and slants in order to feed the strips one-by-one to the second pair of cutting rollers.

12. A machine for obtaining rubber pellets from used tires according to claim 1, wherein further comprises means to support the roller axis which includes the cutting discs in said first or second pair of cutting rollers.

13. A machine for obtaining rubber pellets from used tires according to claim 12, wherein said supporting means are a bearing which covers the roller axis that includes the cutting discs in said first or second pair of cutting rollers; and an elongated base fixed to the frame and attached to the bearing.

14. A machine for obtaining rubber pellets from used tires according to claim 1, wherein the machine further comprises sharpening means to sharpen the cutting discs of said first or second pair of cutting rollers, wherein the sharpening means are mounted on the frame and are in contact with the cutting means when the edge thereof needs to be recovered.

15. A machine for obtaining rubber pellets from used tires according to claim 14, wherein the sharpening means are conformed by a motor and a retractile head mounted on the motor.

16. A machine for obtaining rubber pellets from used tires according to claim 1, wherein further comprises means to self-adjust the separation distance between the rollers of the first pair of cutting rollers, the cutting rollers being one above the other defining an upper roller and a lower roller.

17. A machine for obtaining rubber pellets from used tires according to claim 16, wherein said self-adjusting means comprises:
an end bearing wherein an upper roller axis end is received;
a bearing base disposed slidably mounted on the frame to freely move in the vertical direction and wherein the end bearing is housed;
a threaded rod disposed vertically with respect to the frame, the rod lower end freely goes inside the bearing base and the upper end is fixed to the frame;
a retainer wherein said threaded rod lower end is anchored inside said bearing base such that the bearing base remains spaced apart underneath the frame; and,
elastic means covering the remaining threaded rod portion between the bearing base and the frame;
wherein when the bearing base ascends allows the upper roller to move upwards from the lower roller in order for tire segments of different thickness to be processed in the machine; the elastic means further exerts a descendent pressure over the corresponding bearing base, and as a consequence, the pressure is transmitted to the upper roller in order for the tire segment to be pressed against the lower roller.

18. A machine for obtaining rubber pellets from used tires according to claim 1, wherein the tire segment is obtained from the tire tread or from the sidewalls thereof.

19. A machine for obtaining rubber pellets from used tires according to claim 1, wherein the tire segment has a length of from 20 to 50 cm long.

20. A machine for obtaining rubber pellets from used tires according to claim 1, comprising:
a pair of feeding rollers rotationally mounted on the frame and spaced apart from each other, both feeding rollers rotate in opposite directions, wherein the tire segment is fed in the gap formed between both feeding rollers and is pulled thereby as said feeding rollers rotate; and,
a pair of extraction rollers rotationally mounted on the frame and located following the first pair of cutting rollers, both extraction rollers rotate in opposite directions wherein the strips are pulled and trapped by the extraction rollers as they rotate.

21. A machine for obtaining rubber pellets from used tires according to claim 20, wherein both feeding rollers are provided with microgrooves at their surface.

22. A machine for obtaining rubber pellets from used tires according to claim 20, wherein both extraction rollers are provided with microgrooves at their surface.
